(19) United States
(12) Patent Application Publication
(10) Pub. No.: US 2011/0221782 A1
(43) Pub. Date: Sep. 15, 2011

(54) ELECTRONIC DOCUMENT PROCESSING APPARATUS, COMPUTER READABLE MEDIUM STORING PROGRAM AND METHOD FOR PROCESSING ELECTRONIC DOCUMENT

(75) Inventor: Yasuhiro ITO, Yokohama-shi (JP)

(73) Assignee: FUJI XEROX CO., LTD., Tokyo (JP)

(21) Appl. No.: 12/860,309

(22) Filed: Aug. 20, 2010

(30) Foreign Application Priority Data
Mar. 12, 2010 (JP) 2010-055976

(51) Int. Cl. G09G 5/373

(52) U.S. Cl. 345/671

(57) ABSTRACT

An electronic document processing apparatus includes: a storage unit that holds region information indicating a region of an electronic document, storage destination information indicating a storage destination of the electronic document, and form information on a form electronic document as a form of an electronic document of the storage destination, linked with each other; a display unit that displays the electronic document and the form electronic document; and an input/output controller that, when the storage destination is designated, controls the display unit so as to enlarge-display a region corresponding to region information linked with the storage destination and stored in the storage unit, in comparison with other regions.

### CROSS-REFERENCE TO RELATED APPLICATIONS

This application is based on and claims priority under 35 USC 119 from Japanese Patent Application No. 2010-055976 filed Mar. 12, 2010.

### BACKGROUND

### Technical Field

The present invention relates to an electronic document processing apparatus, a computer readable medium storing a program and a method for processing an electronic document.

### SUMMARY

According to an aspect of the present invention there is provided an electronic document processing apparatus including: a storage unit that holds region information indicating a region of an electronic document, storage destination information indicating a storage destination of the electronic document, and form information on a form electronic document as a form of an electronic document of the storage destination, linked with each other; a display unit that displays the electronic document and the form electronic document; and an input/output controller that, when the storage destination is designated, controls the display unit so as to enlarge-display a region corresponding to region information linked with the storage destination and stored in the storage unit, in comparison with other regions.

### BRIEF DESCRIPTION OF THE DRAWINGS

An exemplary embodiment of the present invention will be described in detail based on the following figures, wherein:

FIG. 1 is a block diagram showing a hardware configuration of an electronic document processing apparatus according to an exemplary embodiment of the present invention;

FIG. 2 is a block diagram showing a software configuration of a first electronic document processing program;

FIG. 3 illustrates an example of a correspondence table stored in a correspondence table storage part 244 of the first electronic document processing program;

FIG. 4 is a flowchart showing an operation flow (S10) of the first electronic document processing program;

FIGS. 5A through 5F illustrate screen examples displayed on a display;

FIG. 6 is a flowchart showing an operation flow (S20) of a second electronic document processing program;

FIG. 7A through illustrate screen examples displayed on the display.

### DETAILED DESCRIPTION

Hereinbelow, an exemplary embodiment of the present invention will be described. Note that the following description is merely an example of implementation of the present invention and the present invention is not limited to the example described below but may be arbitrarily changed in accordance with necessity.

For example, in the following exemplary embodiment of the present invention, a scanned document is stored in a folder of a file server; however, the present invention is not limited to this arrangement. It may be arranged such that an electronic document generated in an electronic document processing apparatus is stored in a folder of the electronic document processing apparatus.

Further, a form of an electronic document stored in a folder is displayed, together with an electronic document to be stored in the folder, on a display or the like of the electronic document processing apparatus; however, the present invention is not limited to this arrangement. It may be arranged such that any of electronic documents already stored in the folder is displayed. For example, among the stored electronic documents, an electronic document with the latest generation date may be displayed.

Note that the scanned document is an electronic document read with a scanner. The electronic document is electronic data having any one of or combination of text data, figure data, image data and the like, which is the subject of storage, editing, search or the like, and which is individually transmitted/received in a system or among users, further, which includes similar data. Further, the form of an electronic document is electronic data indicating the format and style common to electronic documents of the same type. The form of form electronic document can be used as a sample upon generation of an electronic document, and includes similar data. Hereinbelow, the form of electronic document will be simply referred to as a form.

### [Hardware Configuration of Electronic Document Processing Apparatus]

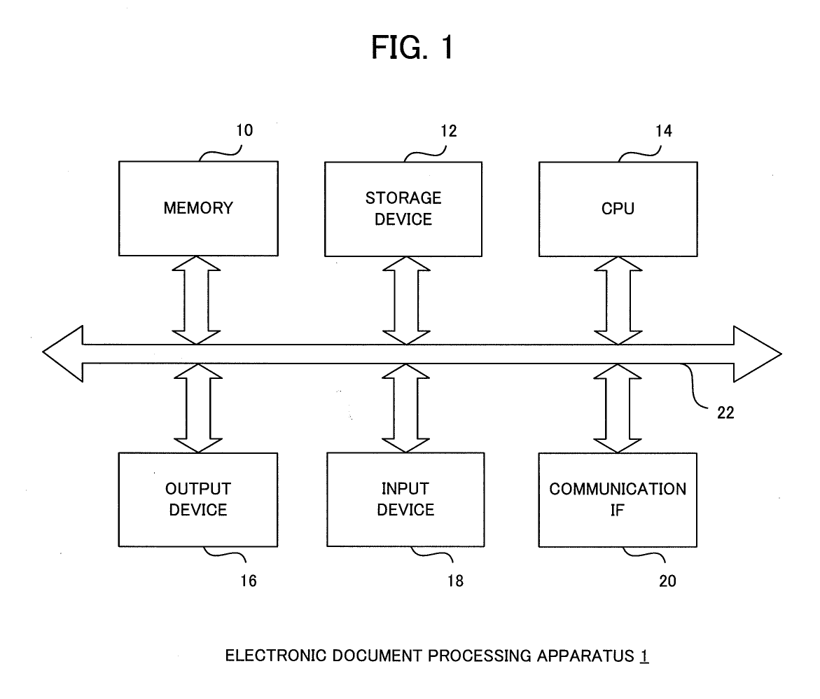

FIG. 1 is a block diagram showing a hardware configuration of an electronic document processing apparatus 1 according to an exemplary embodiment of the present invention. As shown in FIG. 1, the electronic document processing apparatus 1 has a memory 10, a storage device 12 such as an HDD (Hard Disk Drive), a CPU 14, an output device 16 such as a display, an input device 18 including a keyboard, a mouse and the like, and a communication interface 20 (hereinbelow, communication IF 20) for data transmission/reception with other devices such as a scanner and a file server.

These components are communicably interconnected via a control bus 22.

The memory 10 holds an electronic document processing program to be described later or the like.

The storage device 12 holds a scanned document and the like.

The CPU 14 controls the operation of the electronic document processing apparatus 1 such that predetermined processing is performed on a scanned document or the like based on the electronic document processing program or the like stored in the memory 10.

The output device 16 displays electronic document(s) stored in the storage device 12 and a folder holding electronic document(s) (for example, a folder of a file server connected via the communication IF 20) or the like as icons.

The input device 18 receives an operation input with respect to an electronic document or the like from a user.

As an operation input, for example, mouse button depression (click) in a state where a mouse cursor is placed over an icon displayed on the output device 16, movement of the mouse (drag) while the mouse button is depressed, release of the mouse button (drop) in a position after the movement, can be given.

Note that the icon is a small picture or a symbol indicating processing performed in the electronic document processing apparatus 1 and the subject of the processing, and the thumbnail is an image obtained by reducing the content of an electronic document.

### [Software Configuration of Electronic Document Processing Apparatus]

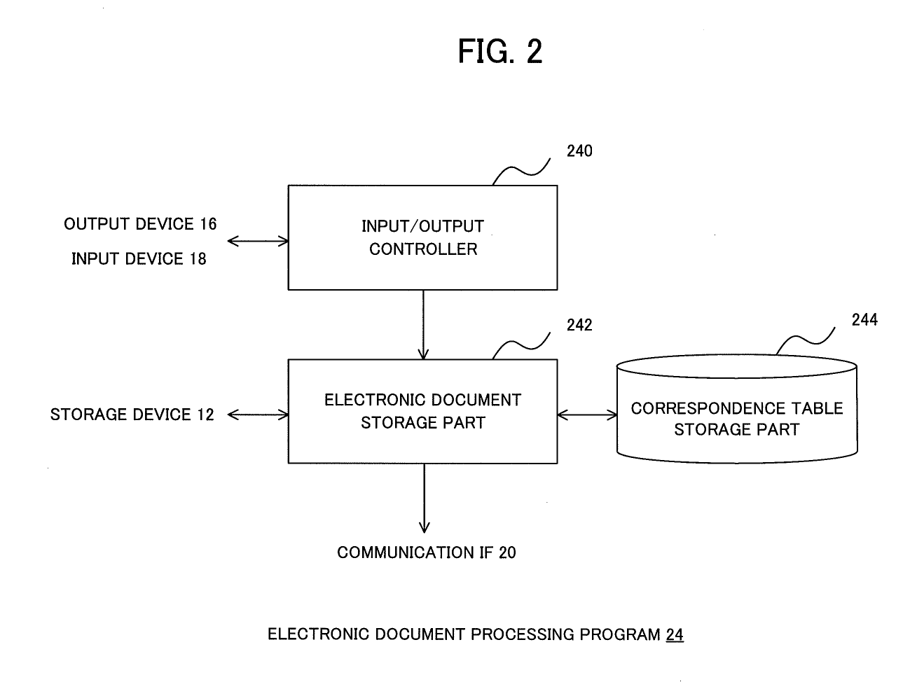

FIG. 2 is a block diagram showing a software configuration of the first electronic document processing program 24 which operates on the document processing apparatus 1 in FIG. 1.

As shown in FIG. 2, the first electronic document processing program 24 has an input/output controller 240, an electronic document storage part 242 and a correspondence table storage part 244.

With the above-described configuration, a scanned document is automatically stored into a folder, and a scanned document which has not been automatically stored is manually stored into the folder by the user.

When the input device 18 in FIG. 1 receives an input of operation by the user (user operation), the input/output controller 240 transmits the user operation to the electronic document storage part 242.

When the user operation from the input/output controller 240 is to store a scanned document stored in the storage device 12 in FIG. 1, the electronic document storage part 242 stores the scanned document into the folder of the file server connected via the communication IF 20 in FIG. 1 or the like (automatic storage).

Further, the electronic document storage part 242 stores the scanned document into the folder of the file server connected via the communication IF 20 or the like based on the user operation from the input/output controller 240 (manual storage).

In the case of automatic storage, the electronic document storage part 242 performs character recognition on the scanned document stored in the storage device 12, and analyzes regions in the scanned document and types of characters included in the respective regions.

Further, the electronic document storage part 242 reads a correspondence table stored in the correspondence table storage part 244, determines the type of the scanned document based on the correspondence table, and stores the scanned document into a storage destination corresponding to the type of the scanned document.

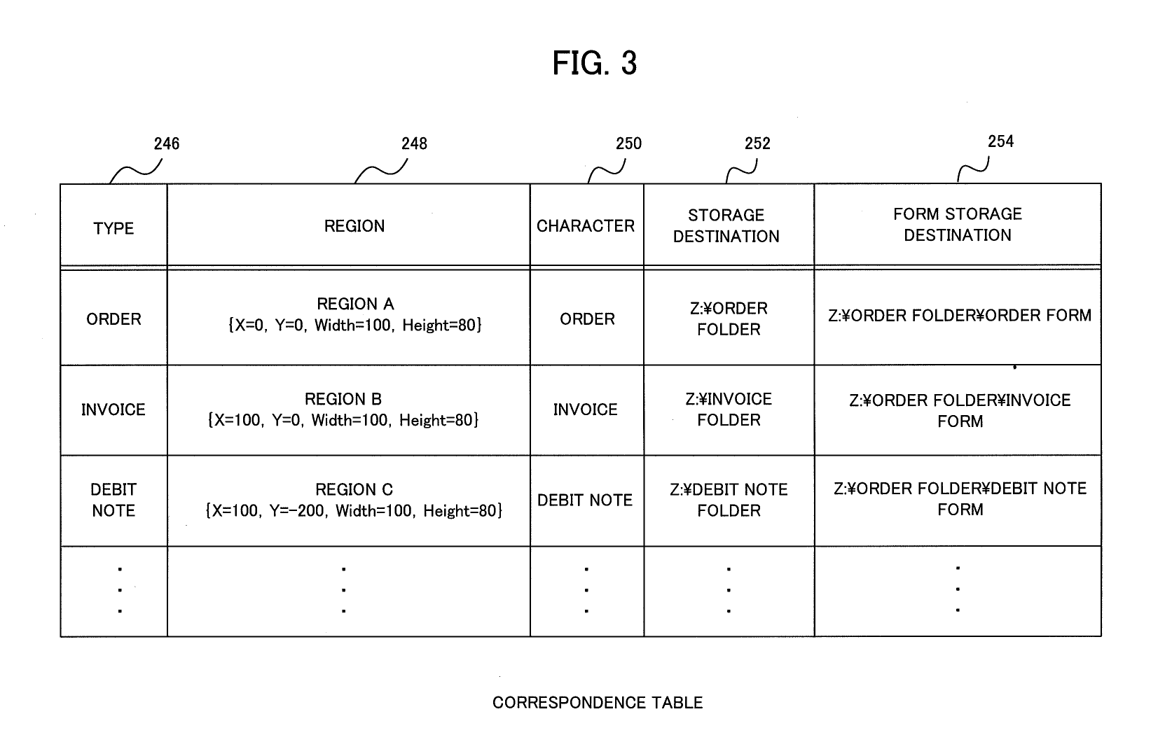

The correspondence table is stored in the correspondence table storage part 244 in e.g. the format as shown in FIG. 3. As shown in FIG. 3, in the correspondence table, five data items of “type” 246, “region” 248, “character” 250, “storage destination” 252 and “form storage destination” 254 are linked with each other.

For example, in a scanned document, when characters “order” are included in a region A{X=0, Y=0, Width=100, Height=80}, the type of the scanned document is determined as an “order”, and the scanned document is stored into a “Z:¥order folder”.

Note that in the correspondence table in FIG. 3, different regions are linked to respective types of scanned document; however, the same region may be linked to the respective types. Further, a scanned document as the object of storage may be stored in plural storage destinations. In this case, the item “storage destination” 252 is not necessarily set in the correspondence table in FIG. 3.

Further, the electronic document storage part 242 outputs, to the input/output controller 240, information on a scanned document, which has not been stored in any folder because e.g. the image quality of the scanned document is poor and character recognition has failed and it is impossible to determine the type of the scanned document (hereinbelow, such scanned document will be referred to as a “unstored scanned document”). Note that the electronic document storage part 242 may store the unstored scanned document in a predetermined folder.

In the case of manual storage, the input/output controller 240 controls information outputted to the output device 16 in FIG. 1 so as to display the unstored scanned document and a folder described in the “storage destination” in the correspondence table as icons. In the following description, an object displayed as an icon will be angle-bracketed (for example, <unstored scanned document> and <folder>), and the object itself may be unbracketed.

Further, the input/output controller 240 receives inputs of operations to drag an <unstored scanned document> to a <folder> and to drop the <unstored scanned document> in the <folder>, and the like, from the input device 18 in FIG. 1.

When an input of the user operation to drag the <unstored scanned document> to the <folder> is received by the input device 18 and the user operation is transmitted by the input/output controller 240, the electronic document storage part 242 reads the correspondence table stored in the correspondence table storage part 244, and based on the correspondence table, designates a folder corresponding to the <folder> among the “storage destinations” in the correspondence table, as a storage destination of the unstored scanned document corresponding to the <unstored scanned document>.

Further, when an input of the user operation to drop the <unstored scanned document> in the <folder> is received by the input device 18 and the user operation is transmitted by the input/output controller 240, the electronic document storage part 242 stores the unstored scanned document corresponding to the <unstored scanned document> in the folder corresponding to the <folder>.

Note that the input/output controller 240 may receive an input of the user operation to drag (and drop) the <unstored scanned document> to a region away from the <folder> by a predetermined distance from the input device 18.

In this case, the electronic document storage part 242 designates the folder corresponding to the <folder> as a storage destination of the unstored scanned document corresponding to the <unstored scanned document> or stores the unstored scanned document corresponding to the <unstored scanned document> in the folder corresponding to the <folder>, in accordance with the distance from the <folder>.

Further, when the input of the user operation to drag the <unstored scanned document> to the <folder> is received by the input device 18, the input/output controller 240 controls information outputted to the output device 16 so as to thumbnail-display the unstored scanned document corresponding to the <unstored scanned document> in a position before dragging and in the vicinity of the <folder>, thumbnail-display a form stored in the “form storage destination” corresponding to the designated “storage destination”, and enlarge-display a “region” corresponding to the designated “storage destination” in the thumbnail of the unstored scanned document and the thumbnail of the form.

Note that the positions in which the respective thumbnails are displayed are not limited to the above-described positions but may be positions in which the displayed thumbnails do not overlap each other.

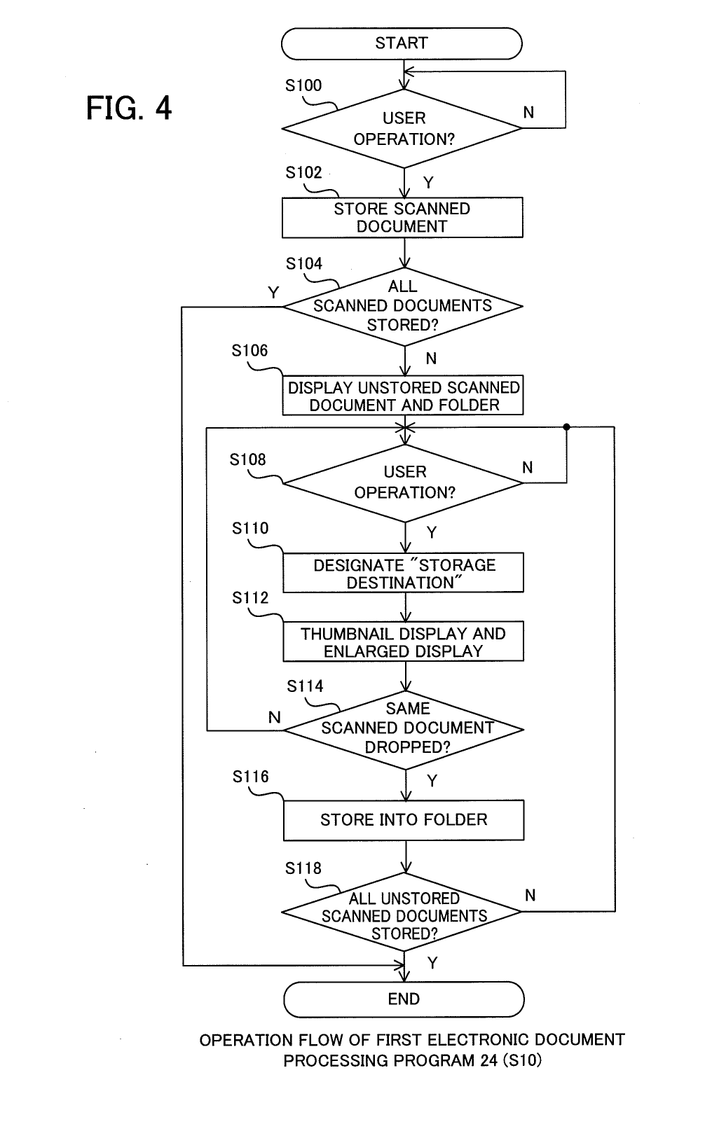

FIG. 4 is a flowchart showing an operation flow (S10) of the first electronic document processing program 24 which operates on the electronic document processing apparatus 1 in FIG. 1.

As shown in FIG. 4, at step S100, the input/output controller 240 in FIG. 2 determines whether or not an input of the user operation to store a scanned document has been received by the input device 18 in FIG. 1. When it is determined that the input of the user operation has been received, the process proceeds to step S102, otherwise, the processing at step S100 is repeated.

At step S102, the electronic document storage part 242 in FIG. 2 performs the user operation received at step S100. More particularly, the electronic document storage part 242 determines the type of the scanned document based on the correspondence table stored in the correspondence table storage part 244 in FIG. 2 using the result of analysis of character recognition of the scanned document, and stores the scanned document in a storage destination corresponding to the type of the scanned document. Note that when plural scanned documents exist, the processing at step S102 is repeated for each of the scanned documents.

At step S104, the electronic document storage part 242 determines whether or not all the scanned documents stored in the storage device 12 have been stored into folders. When it is determined that all the scanned document have been stored, the process ends, while when it is determined that an unstored scanned document exists, the process proceeds to step S106.

At step S106, the input/output controller 240 controls information outputted to the output device 16 in FIG. 1 so as to display the unstored scanned document and a folder described in the “storage destination” in the correspondence table as icons. Note that the processing at step S106 may be performed after the processing at step S100. In this case, the automatic storage is not performed but only the manual storage is performed.

At step S108, the input/output controller 240 determines whether or not inputs of the user operation to drag the <unstored scanned document> to the <folder> and to drop the <unstored scanned document> in the <folder> have been received by the input device 18. When it is determined that the inputs of the user operation have been received, the process proceeds to step S110, otherwise, the processing at step S108 is repeated.

At step S110, the electronic document storage part 242 designates a folder corresponding to the <folder> which is a dragging destination at step S108 among the “storage destinations” in the correspondence table, as a storage destination of the unstored scanned document corresponding to the <unstored scanned document> dragged at step S108.

At step S112, when the input of the operation to drag the <unstored scanned document> to the <folder> has been received by the input device 18, the input/output controller 240 controls information outputted to the output device 16 so as to thumbnail-display the unstored scanned document corresponding to the <unstored scanned document> in a position before the dragging, and in the vicinity of the <folder>, thumbnail-display a form stored in the “form storage destination” corresponding to the designated “storage destination”, and enlarge-display a “region” corresponding to the designated “storage destination” in the thumbnail of the unstored scanned document and the thumbnail of the form.

At step S114, the input/output controller 240 determines whether or not the input of the user operation to drop the <unstored scanned document> dragged at step S112 in the <folder> has been received by the input device 18. When it is determined that the input of the user operation has been received, the process proceeds to step S110, otherwise, returns to step S108.

At step S116, the electronic document storage part 242 stores the unstored scanned document corresponding to the <unstored scanned document> dropped at step S114 in a folder corresponding to the <folder> as the destination of the dropping at step S114.

At step S118, the electronic document storage part 242 determines whether or not all the unstored scanned documents icon-displayed at step S106 have been stored in the folders. When it is determined that all the unstored scanned documents have been stored, the process ends, otherwise, the processing at steps S108 to S118 is repeated.

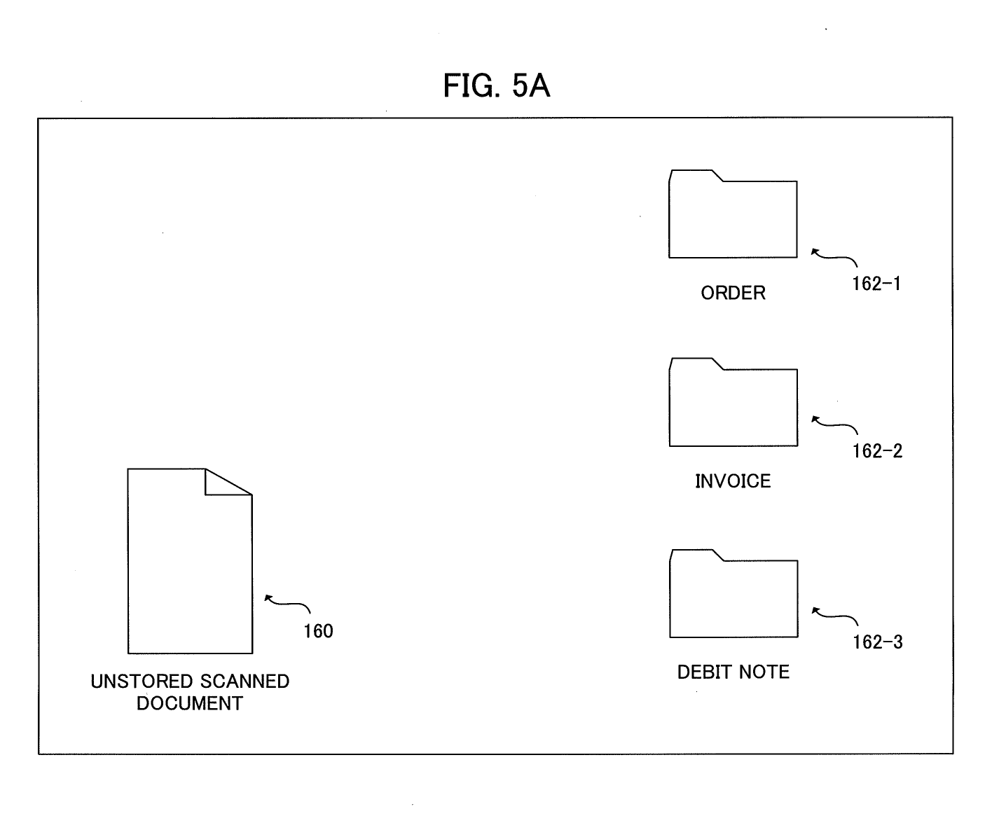

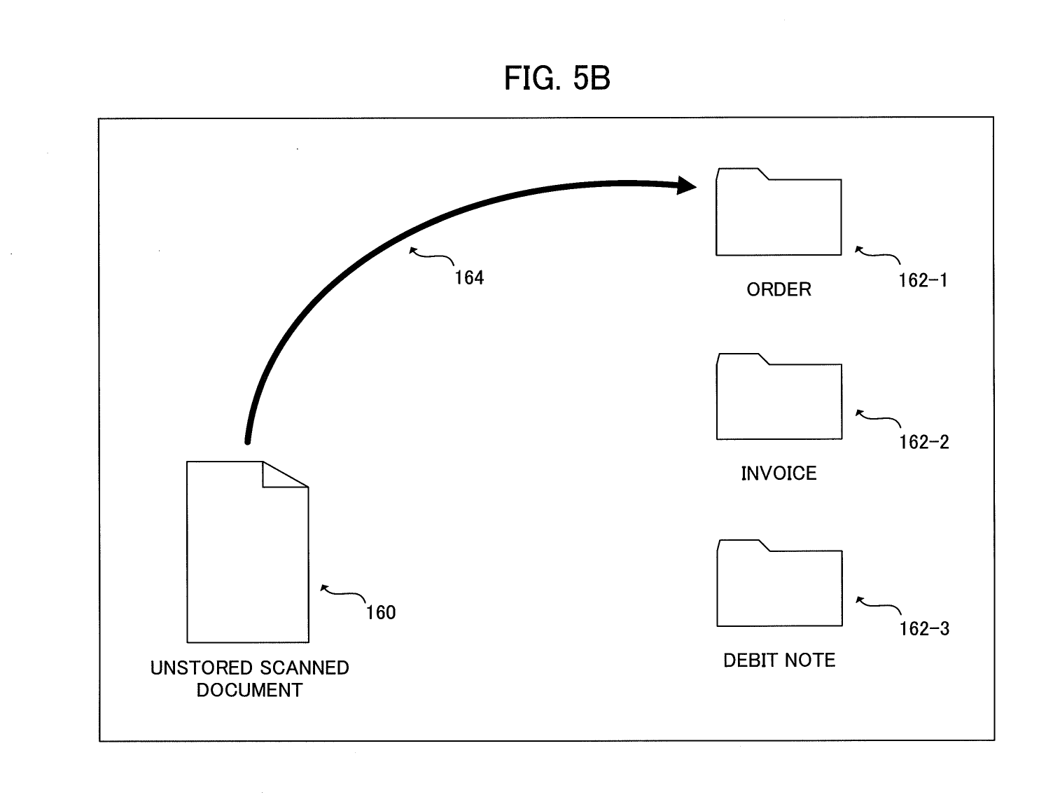

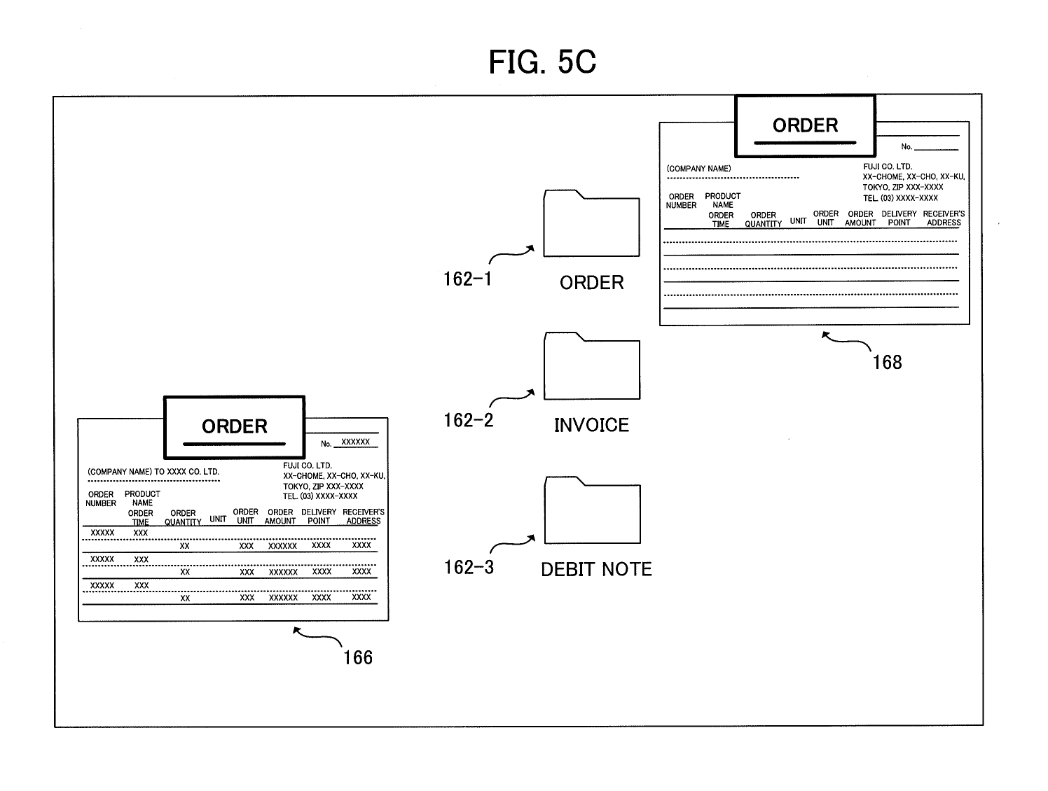

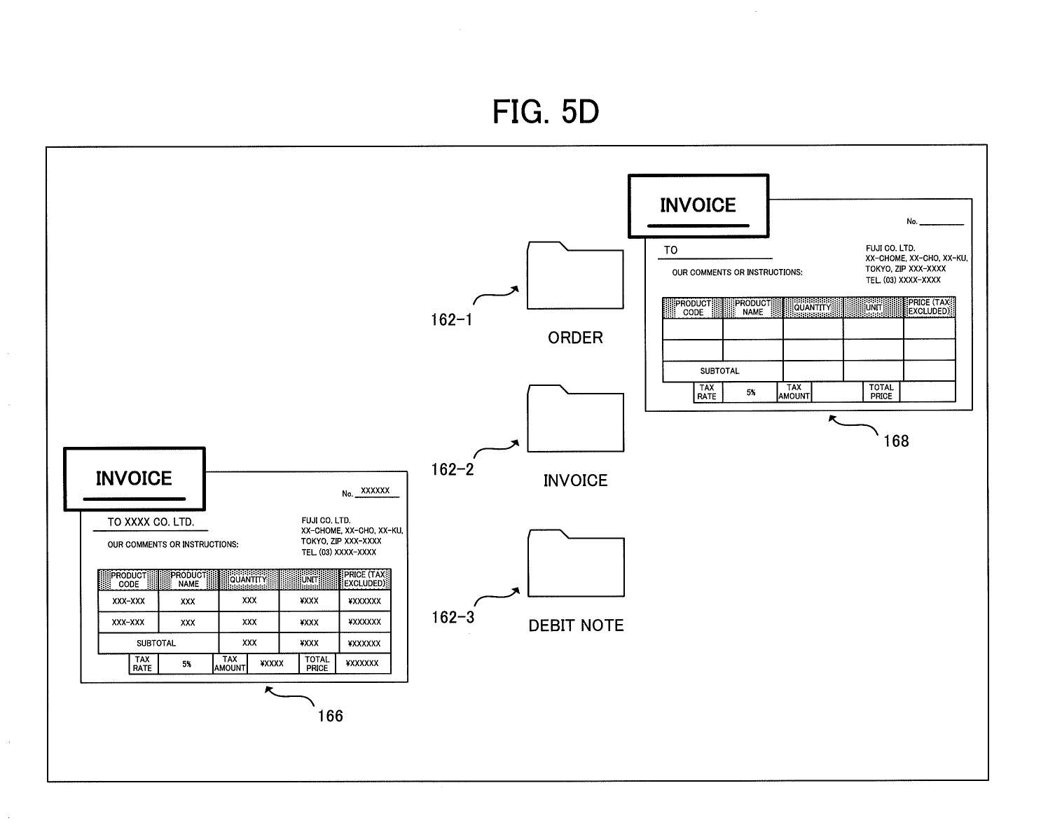

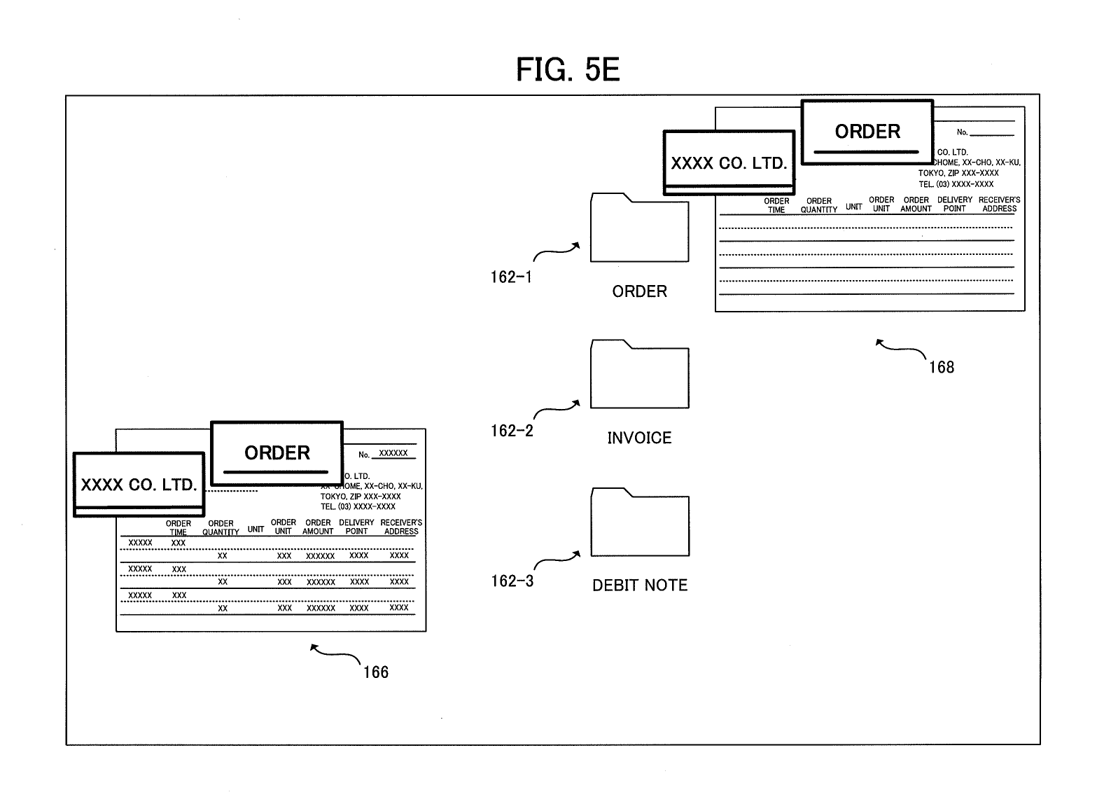

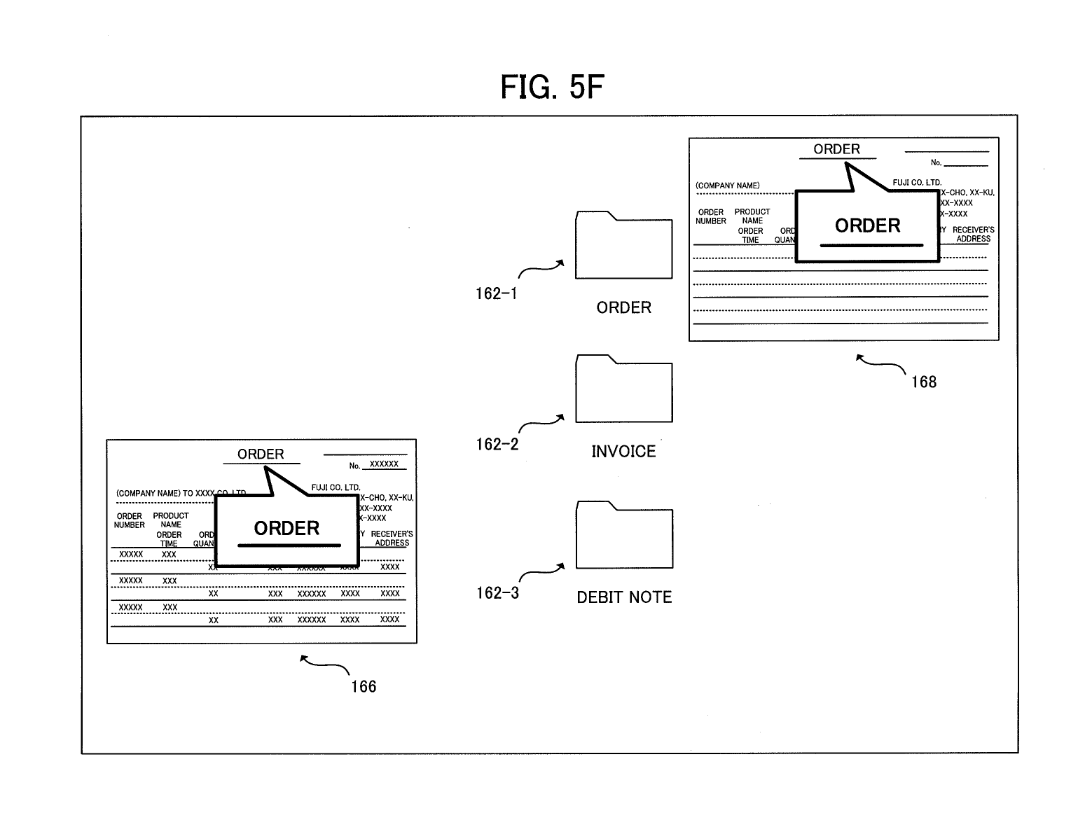

Hereinbelow, screen examples or the like displayed on a display (not shown) as the output device 16 will be described with reference to FIGS. 5A to 5F.

FIG. 5A illustrates a screen example displayed at step S106 in FIG. 4.

As shown in FIG. 5A, an <unstored scanned document> 160, a <folder> 162 in which a scanned document is stored (here an <order> 162-1, an <invoice> 162-2 and a <debit note> 162-3) are displayed.

In the screen example in FIG. 5A, as shown in FIG. 5B, the <unstored scanned document> 160 can be dragged along an arrow 164 direction to the <folder> 162 (here <order> 162-1). When the <unstored scanned document> 160 is dragged to the <folder> 162, an unstored scanned document corresponding to the <unstored scanned document> 160 and a form corresponding to the <folder> 162 are thumbnail-displayed and enlarge-displayed. Further, the <unstored scanned document> 160 can be dropped in the <folder> 162. When the <unstored scanned document> 160 is dropped in the <folder> 162, the unstored scanned document corresponding to the <unstored scanned document> 160 is stored in the folder corresponding to the <folder> 162.

Note that in the following description, the number of layers of the <folder> 162 is one; however, the number of layers may be two or more. In a case where the <folder> 162 has a <sub folder> (not shown), when the <unstored scanned document> 160 is dragged to any <sub folder>, thumbnail display and enlarged display are produced.

FIG. 5C illustrates another screen example displayed at step S112.

As shown in FIG. 5C, in a position 166 before the <unstored scanned document> 160 is dragged to the <folder> 162 (here the <order> 162-1), an unstored scanned document corresponding to the <unstored scanned document> 160 is thumb-nail displayed, and in a position 168 in the vicinity of the <folder> 162, a form corresponding to the <folder> 162 is thumbnail-displayed. In the thumbnail of the unstored scanned document corresponding to the <unstored scanned document> 160 and in the thumbnail of the form, a region corresponding to the <folder> 162 (here a title part in an upper central position) is enlarge-displayed.

FIG. 5D illustrates another screen example displayed at step S112 in FIG. 4.

As shown in FIG. 5D, in the position 166 before the <unstored scanned document> 160 is dragged to the <folder> 162 (here the <invoice> 162-2), an unstored scanned document corresponding to the <unstored scanned document> 160 is thumb-nail displayed, and in the position 168 in the vicinity of the <folder> 162, a form corresponding to the <folder> 162 is thumbnail-displayed. In the thumbnail of the unstored scanned document corresponding to the <unstored scanned document> 160 and in the thumbnail of the form, a region corresponding to the <folder> 162 (here a title part in an upper left position) is enlarge-displayed.

In this manner, a region which differs by document type may be enlarge-displayed.

FIG. 5E illustrates another screen example displayed at step S112 in FIG. 4.

As shown in FIG. 5E, in the position 166 before the <unstored scanned document> 160 is dragged to the <folder> 162 (here the <order> 162-1), an unstored scanned document corresponding to the <unstored scanned document> 160 is thumb-nail displayed, and in the position 168 in the vicinity of the <folder> 162, a form corresponding to the <folder> 162 is thumbnail-displayed. In the thumbnail of the unstored scanned document corresponding to the <unstored scanned document> 160 and in the thumbnail of the form, plural different regions corresponding to the <folder> 162 (here a correspondent name part in an upper left position and a title part in an upper central position) are enlarge-displayed.

In this manner, plural different regions may be enlarge-displayed. Note that it may be arranged such that the plural different regions are simultaneously enlarge-displayed, or enlarged display of one region and another region, at predetermined periods, is repeated.

FIG. 5F illustrates another screen example displayed at step S112 in FIG. 4.

As shown in FIG. 5F, in the position 166 before the <unstored scanned document> 160 is dragged to the <folder> 162 (here the <order> 162-1), an unstored scanned document corresponding to the <unstored scanned document> 160 is thumb-nail displayed, and in the position 168 in the vicinity of the <folder> 162, a form corresponding to the <folder> 162 is thumbnail-displayed. In the thumbnail of the unstored scanned document corresponding to the <unstored scanned document> 160 and in the thumbnail of the form, a region corresponding to the <folder> 162 (here a title part in an upper central position) is pop-up displayed.

In this manner, the region may be pop-up displayed.

Hereinbelow, a second electronic document processing program 26 which operates on the electronic document processing apparatus 1 in FIG. 1 will be described.

The second electronic document processing program 26 has the same software configuration as that of the first electronic document processing program 24.

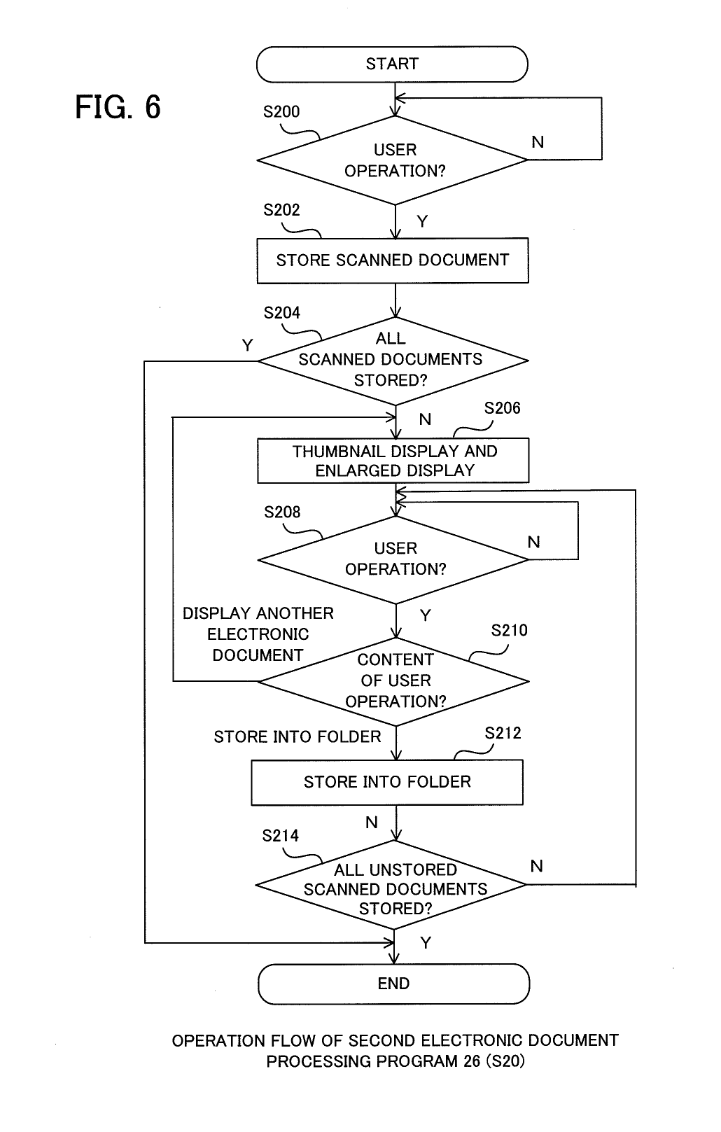

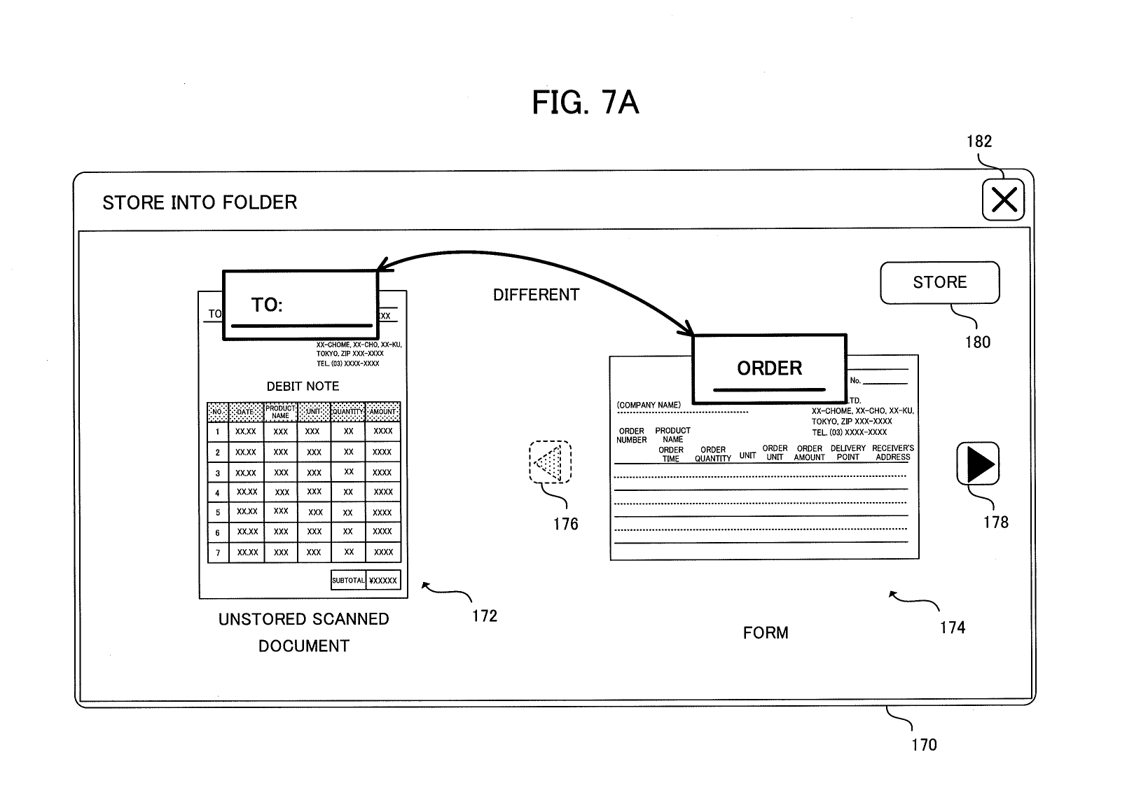

FIG. 6 is a flowchart showing an operation flow (S20) of the second electronic document processing program 26 which operates on the electronic document processing apparatus 1 in FIG. 1.

In FIG. 6, at steps S200 to S204 and steps S212 to S214, the same processing as that in steps S100 to S104 and steps S116 to S118 in FIG. 4 is performed.

At step S206, the input/output controller 240 in FIG. 2 controls information outputted to the output device 16 in FIG. 1 so as to thumbnail-display an unstored scanned document and an electronic document stored in the “form storage destination” in the correspondence table and enlarge-display a “region” corresponding to the “form storage destination” in the thumbnail of the unstored scanned document and in the thumbnail of the electronic document.

For example, the input/output controller 240 controls information outputted to the output device 16 so as to thumbnail-display an unstored scanned document and a form stored in the “form storage destination” described in the correspondence table within the same window, and enlarge-display a “region” corresponding to the “form storage destination” in which the form is stored in the thumbnail of the unstored scanned document and in the thumbnail of the form.

Note that after the processing at step S204, when other steps have not been performed, the input/output controller 240 controls information outputted to the output device 16 so as to thumbnail-display e.g. a form stored in a “form storage destination” described in a top row of the correspondence table.

After the processing at step S240, when the other steps S206 to S210 have been performed, the input/output controller 240 controls information outputted to the output device 16, in accordance with the number of repetition in the determination at step S210, so as to thumbnail-display e.g. a form stored in a “form storage destination” described in a row of the correspondence table below the top row by the number of repetition in the determination at step S210. When the determination at step S210 has been performed once, the input/output controller 240 controls information outputted to the output device 16 so as to thumbnail-display a form stored in a “form storage destination” described in a row of the correspondence table next to the top row at step S206.

At step S208, the input/output controller 240 receives an input of the user operation to store the unstored scanned document into a folder corresponding to the form thumbnail-displayed at step S206 and an input of the user operation to thumbnail-display the unstored scanned document and a form different from the form thumbnail-displayed at step S206, from the input device 18 in FIG. 1.

For example, the input/output controller 240 controls information outputted to the output device 16 so as to display a button for determination of a folder corresponding to the thumbnail-displayed form as a storage destination of the unstored scanned document and a button for thumbnail-display of the unstored scanned document and a form stored in a “form storage destination” described in the row next to the top row of the correspondence table in the window.

At step S210, the input/output controller 240 determines the contents of the input of the user operation received by the input device 18 at step S208. When it is determined at step S208 that an input of the user operation for storage in the folder has been received, the process proceeds to step S212, while when it is determined that an input of the user operation for thumbnail display has been received, the process returns to step S206.

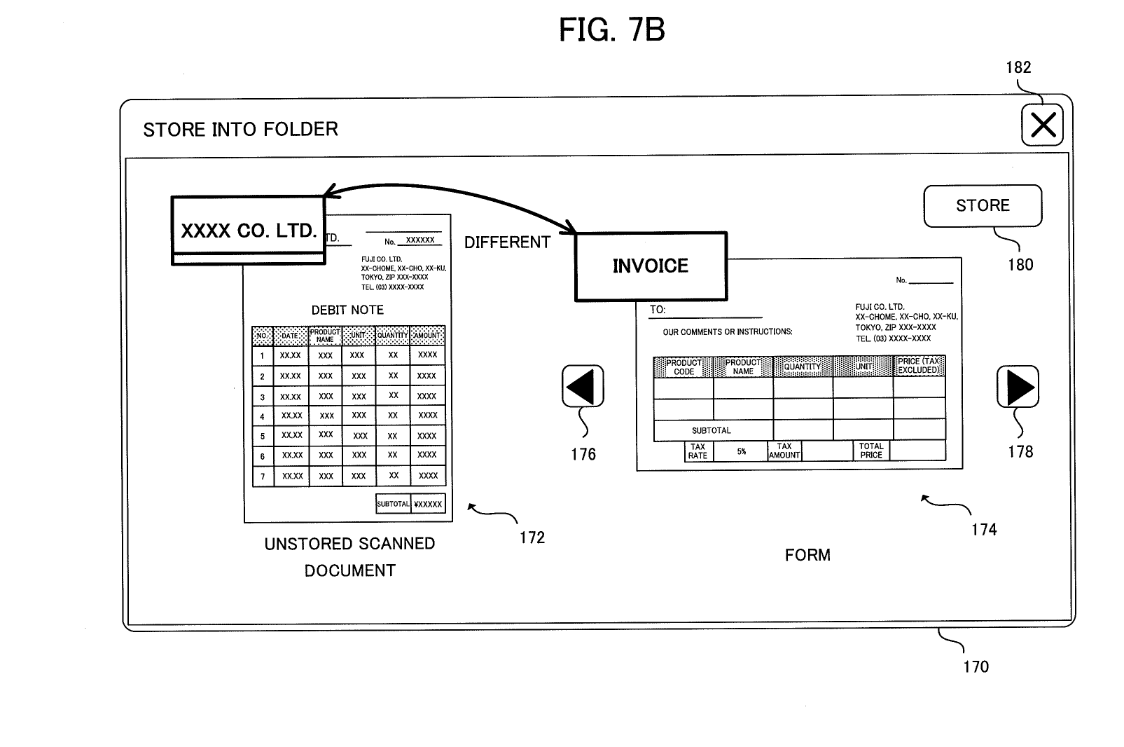

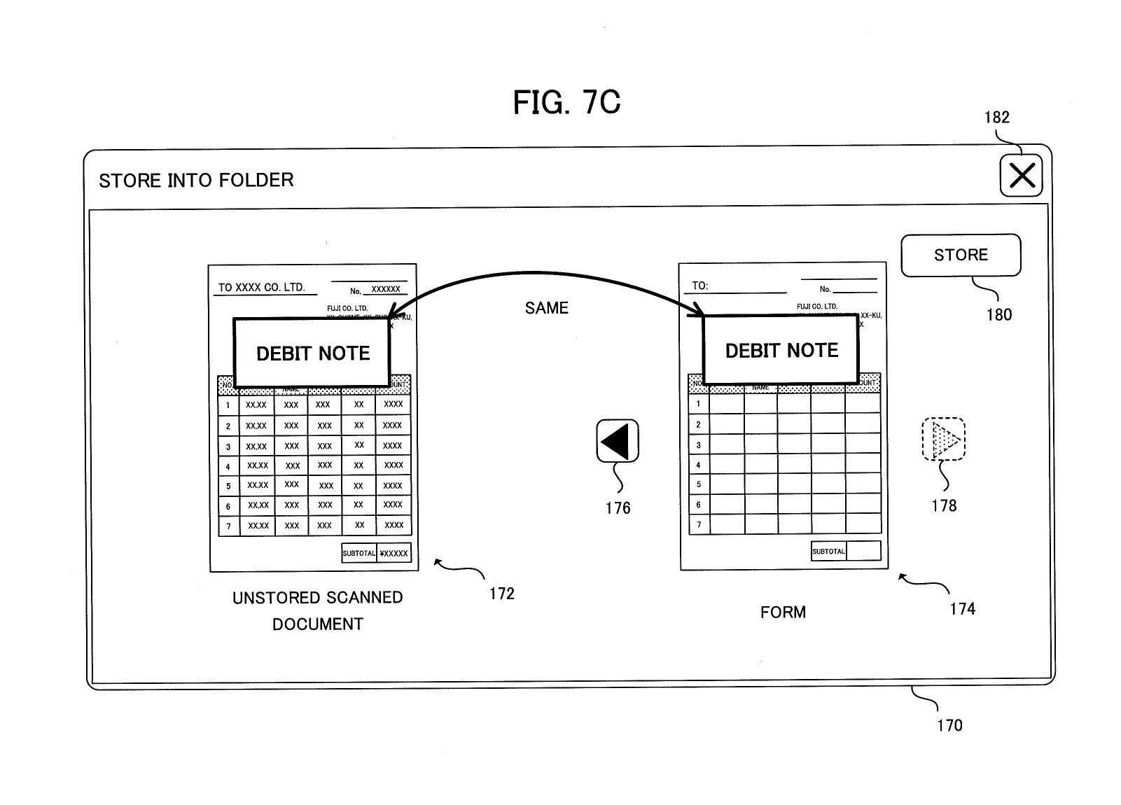

Hereinbelow, screen examples or the like displayed on the display (not shown) as the output device 16 in FIG. 1 will be described with reference to FIGS. 7A to 7C.

FIG. 7A illustrates a screen example displayed at step S206 in FIG. 6.

As shown in FIG. 7A, within a window 170, a thumbnail 172 of an unstored scanned document, a thumbnail 174 of a form for a document stored in a folder (here an invoice form), a button 176 to return to a previous form, a button 178 to proceed to the next form, a storage button 180 to determine a folder corresponding to the displayed form 174 as a storage destination of the unstored scanned document 172, and a button 182 to close the window 170 are displayed. Note that a broken line indicates an invalidated part. In this example, no previous form exists, and the return button 176 is invalidated (similar display is produced when the next form does not exist).

As shown in FIG. 7A, the unstored scanned document and the form are thumbnail-displayed, and further, a region corresponding to the storage destination of the form (here a title part) is enlarge-displayed.

As shown in this example, when characters and the like enlarge-displayed in the thumbnail of the unstored scanned document are different from characters and the like enlarge-displayed in the thumbnail of the form, the user determines not to store the unstored scanned document into a folder corresponding to the displayed form. In this case, the user does not press the storage button 180, but presses the proceed button 178 and waits for display of the next form.

FIG. 7B illustrates another screen example displayed after the depression of the proceed button 178 in the example shown in FIG. 7A.

As shown in FIG. 7B, the thumbnail 172 of the unstored scanned document, the thumbnail 174 of a form of a document stored in a folder (here an invoice form), the return button 176, the proceed button 178, the storage button 180 and the close button 182 are displayed within the window 170.

As shown in FIG. 7B, when characters and the like enlarge-displayed in the thumbnail of the unstored scanned document are different from characters and the like enlarge-displayed in the thumbnail of the form, the user determines not to store the unstored scanned document into the folder corresponding to the displayed form. In this case, the user does not press the storage button 180, but presses the proceed button 178 and waits for display of the next form.

FIG. 7C illustrates another screen example displayed after the depression of the proceed button 178 in the example shown in FIG. 7B.

As shown in FIG. 7C, the thumbnail 172 of the unstored scanned document, the thumbnail 174 of a form of a document stored in a folder (here an invoice form), the return button 176, the proceed button 178, the storage button 180 and the close button 182 are displayed in the window 170.

As shown in FIG. 7C, when characters and the like enlarge-displayed in the thumbnail of the unstored scanned document are the same as characters and the like enlarge-displayed in the thumbnail of the form, the user determines to store the unstored scanned document into a folder corresponding to the displayed form. In this case, the user presses the storage button 180, and stores the unstored scanned document into the folder corresponding to the displayed form.

The above-described program may be stored and provided on a storage medium, or may be provided via a communication unit. That is, the present invention can be understood as an invention of a “computer-readable storage medium storing a program”.

The “computer-readable storage medium storing a program” means a computer-readable storage medium storing a program used for installation, execution, distribution or the like of the program. Note that as a storage medium, a digital versatile disc (DVD) in conformance with standards formulated in the DVD forum, “a DVD-R, a DVD-RW, a DVD-RAM or the like”, “a DVD+R, DVD+RW or the like” which is a digital versatile disc (DVD) in conformance with standards formulated in the DVD+RW forum, a compact disc (CD) such as a read-only memory (CD-ROM), a CD-recordable (CD-R), and a CD rewritable (CD-RW), a blue-ray disc (Blu-ray Disc (registered trademark)), a magneto-optical disc (MO), a flexible disc (FD), a magnetic tape, a hard disk, a read-only memory (ROM), an electrically erasable programmable read-only memory (EEPROM), a flash memory, a random-access memory (RAM), and the like are included.

The program or a part of the program may be stored on the storage medium and distributed. Further, the program may be transmitted by communication using a transmission medium such as a cable network or wireless communication network or further a combination thereof used in e.g. a local area network (LAN), a metropolitan area network (MAN), a wide area network (WAN), the Internet, an intranet, an extranet. Further, the program may be carried on a carrier wave.

Further, the above-described program may be a part of another program, or may be stored together with another program on a storage medium. Further, the program may be divided and stored on plural storage media. Further, the program may be stored in any form such as compressed form or coded form as long as it can be recovered.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic document processing apparatus comprising:
a storage unit that holds region information indicating a region of an electronic document, storage destination information indicating a storage destination of the electronic document, and form information on a form electronic document as a form of an electronic document of the storage destination, linked with each other;
a display unit that displays the electronic document and the form electronic document; and
an input/output controller that, when the storage destination is designated, controls the display unit as to enlarge-display a region corresponding to region information linked with the storage destination and stored in the storage unit, in comparison with other regions.

2. The electronic document processing apparatus according to claim 1, wherein when the storage destination is designated, the input/output controller reduce-displays the electronic document and the form electronic document linked with the storage destination and stored in the storage unit, and in the reduce-displayed electronic document and form electronic document, enlarge-displays a region corresponding to the region information linked with the storage destination and stored in the storage unit, in comparison with the other regions.

3. The electronic document processing apparatus according to claim 1,
wherein the storage unit holds a plurality of region information pieces and the storage destination information linked with each other, and
when the storage destination is designated, the input/output controller enlarge-displays a plurality of regions corresponding to the plurality of region information pieces linked with the storage destination and stored in the storage unit, in comparison with the other regions.

4. The electronic document processing apparatus according to claim 1, wherein, when the storage destination is designated, the input/output controller pop-up displays a region corresponding to the region information linked with the storage destination and stored in the storage unit.

5. A computer readable medium storing a program causing a computer to execute a process for electronic document processing, the process comprising:
holding region information indicating a region of an electronic document, storage destination information indicating a storage destination of the electronic document, and form information on a form electronic document as a form of an electronic document of the storage destination, linked with each other;
displaying the electronic document and the form electronic document; and
when the storage destination is designated, performing control so as to enlarge-display a region corresponding to region information linked with the storage destination and stored, in comparison with other regions.

6. A method for processing an electronic document, the method comprising:
holding region information indicating a region of an electronic document, storage destination information indicating a storage destination of the electronic document, and form information on a form electronic document as a form of an electronic document of the storage destination, linked with each other;
displaying the electronic document and the form electronic document; and
when the storage destination is designated, performing control so as to enlarge-display a region corresponding to region information linked with the storage destination and stored, in comparison with other regions.
